(19) United States
(12) Patent Application Publication
(10) Pub. No.: US 2017/0201781 A1
(43) Pub. Date: Jul. 13, 2017

(54) ONLINE MEDIA CONTENT DISTRIBUTION WITH ASSOCIATED TRANSACTIONS

(71) Applicant: Mark Itwaru, Toronto (CA)

(72) Inventor: Mark Itwaru, Toronto (CA)

(21) Appl. No.: 14/994,644

(22) Filed: Jan. 13, 2016

(51) Int. Cl. H04N 21/2543; H04N 21/478; H04N 21/4788; H04N 21/2668; H04N 21/2665

(52) U.S. Cl. CPC H04N 21/25435; H04N 21/2668; H04N 21/2665; H04N 21/4788; H04N 21/47815; G06Q 50/01

(57) ABSTRACT

An online media content distribution framework for sharing media content over a network and for coordinating transactions associated with the shared media content, the framework executed on a computer system using instructions stored on a storage to: register a plurality of content consumers as members of the framework by creating a respective profile account for each content consumer of the plurality of content consumers, each respective profile account including respective member information including respective member identification (ID) and consumer transaction account information; register a content provider as member of the framework by creating a respective profile account for the content provider including a respective member ID and provider transaction account information; receive a broadcast session request over the network from the content provider including the media content via a provider client application coupled to the framework; broadcast the media content to the plurality of content consumers over the network for display on respective consumer computer user interfaces via respective consumer client applications coupled to the framework; receive a transaction amount from one or more of the plurality of content consumers, the transaction amount resulting from activation of a transaction control displayed by the consumer client application on the consumer computer interface, the transaction control associated with the media content and including a displayed transaction amount representing the transaction amount; and send over the network a transaction request for settlement to a transaction platform, the transaction request including the transaction amount, the provider transaction account information and the consumer transaction account information from the one or more of the plurality of content consumers.

### FIELD

The present invention is related to online media content distribution and transaction systems.

### BACKGROUND

Here at the beginning of the 21st century, we as innovators stand in the same position. The advent of personal computing, smart devices, e-commerce, electronic transactions and social networking have created equally rich “cyber-ground” from which, industry hopes, equally brilliant solutions will emerge.

Disadvantages with current media distribution systems are that they are not “Social Commerce Network” compatible. The integration of interactive experiences of social network members with social networking functionality and mobile commerce is lacking. Current systems are not very proficient at organically connecting members with each other, with brick and mortar retailers, online retailers, brands, streaming content and advertisers. Further, current social networks do not facilitate transactions between members of the social network for proffered products and services.

### SUMMARY

Disadvantages with current media distribution systems are that they are not “Social Commerce Network” compatible. The integration of interactive experiences of social network members with social networking functionality and mobile commerce is lacking. It is an object of the present invention to provide a media distribution system and method to obviate or mitigate at least some of the current disadvantages.

A first aspect provided is an online media content distribution framework for sharing media content over a network and for coordinating transactions associated with the shared media content, the framework executed on a computer system using instructions stored on a storage to: register a plurality of content consumers as members of the framework by creating a respective profile account for each content consumer of the plurality of content consumers, each respective profile account including respective member information including respective member identification (ID) and consumer transaction account information; register a content provider as member of the framework by creating a respective profile account for the content provider including a respective member ID and provider transaction account information; receive a broadcast session request over the network from the content provider including the media content via a provider client application coupled to the framework; broadcast the media content to the plurality of content consumers over the network for display on respective consumer computer user interfaces via respective consumer client applications coupled to the framework; receive a transaction amount from one or more of the plurality of content consumers, the transaction amount resulting from activation of a transaction control displayed by the consumer client application on the consumer computer interface, the transaction control associated with the media content and including a displayed transaction amount representing the transaction amount; and send over the network a transaction request for settlement to a transaction platform, the transaction request including the transaction amount, the provider transaction account information and the consumer transaction account information from the one or more of the plurality of content consumers.

A second aspect provided is a method for sharing media content online over a network and for coordinating transactions associated with the shared media content, the method executed on a computer system using instructions stored on a storage for: registering a plurality of content consumers as members of a distribution service by creating a respective profile account for each content consumer of the plurality of content consumers, each respective profile account including respective member information including respective member identification (ID) and consumer transaction account information; registering a content provider as member of the distribution service by creating a respective profile account for the content provider including a respective member ID and provider transaction account information; receiving a broadcast session request over the network from the content provider including the media content via a provider client application coupled to the distribution service; broadcasting the media content to the plurality of content consumers over the network for display on respective consumer computer user interfaces via respective consumer client applications coupled to the distribution service; receiving a transaction amount from one or more of the plurality of content consumers, the transaction amount resulting from activation of a transaction control displayed by the consumer client application on the consumer computer interface, the transaction control associated with the media content and including a displayed transaction amount representing the transaction amount; and sending over the network a transaction request for settlement to a transaction platform, the transaction request including the transaction amount, the provider transaction account information and the consumer transaction account information from the one or more of the plurality of content consumers.

A third aspect provided is a method for receiving media content shared online over a network and for coordinating transactions associated with the shared media content, the method executed on a computer system using instructions stored on a storage for: registering as a content consumer member of a distribution service by obtaining a profile account with the distribution service, the profile account including member information including a member identification (ID) and consumer transaction account information; receiving notification on a user interface of the computer system of a broadcast session over the network from the distribution service for media content provided by a content provider; displaying a broadcast of the media content on the user interface via a consumer client application coupled to the distribution service; generating a transaction amount resulting from activation of a transaction control displayed by the consumer client application on the user interface, the transaction control associated with the media content and a displayed transaction amount representing the transaction amount; and sending over the network the transaction amount for subsequent settlement with a transaction platform as brokered by the distribution service.

A fourth aspect provided is a method for broadcasting media content shared online over a network and for coordinating transactions associated with the shared media content, the method executed on a computer system using instructions stored on a storage for: registering as a content provider member of a distribution service by obtaining a profile account with the distribution service, the profile account including member information including a member identification (ID) and provider transaction account information; submitting via a user interface of the computer system notification of a broadcast session over the network to the distribution service for media content provided by the content provider; sending the media content to the distribution service for subsequent display as a broadcast of the media content on a user interface of a consumer client application coupled to the distribution service; and receiving a transaction amount resulting from activation of a transaction control displayed by the consumer client application on the user interface of the consumer client application, the transaction control associated with the media content and including a displayed transaction amount representing the transaction amount.

### BRIEF DESCRIPTION OF THE DRAWINGS

Features, aspects, and embodiments are described in conjunction with the attached drawings, by way of example only, in which:

FIG. 1 is a schematic representation of a media content distribution environment;

FIG. 2 shows an example media distribution service of the environment of FIG. 1;

FIG. 3 is an example profile account display of a client application of the media distribution service of FIG. 2;

FIG. 4 is an example broadcast screen display of a provider client application of the media distribution service of FIG. 2;

FIG. 5 is an example viewer screen display of a consumer application of the media distribution service of FIG. 2;

FIG. 6 is an example operation of the environment of FIG. 1; and

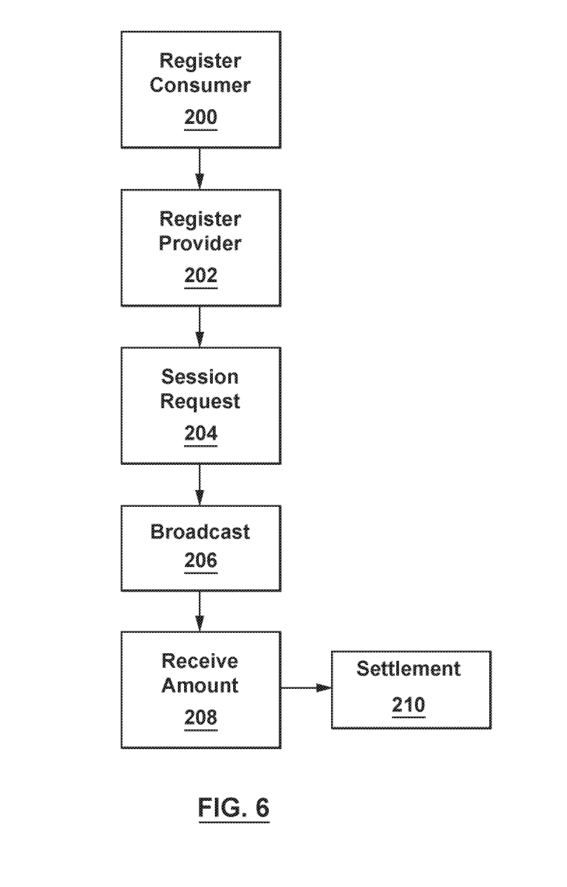

FIG. 7 is an example computer device for implementing the environment of FIG. 1.

### DESCRIPTION OF VARIOUS EMBODIMENTS

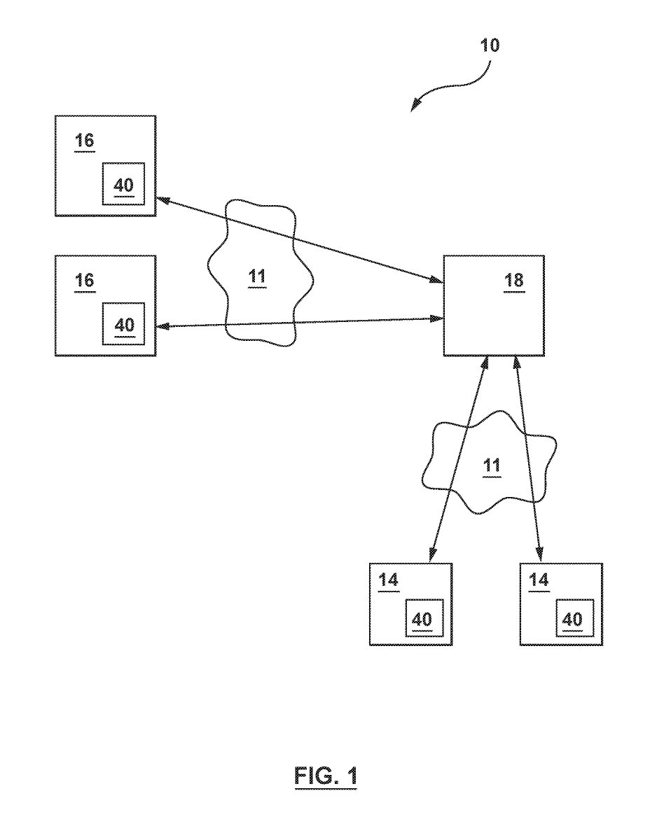

Referring to FIG. 1, shown is a media content sharing environment 10 providing a mobile commerce enabled (e.g. live) media sharing (e.g. video streaming) service facilitating online users to register and view other users media content 12 from anywhere in the world. By leveraging media content sharing and transaction (e.g. payment) technologies, the media content sharing environment 10 providers for all users (e.g. members of a media distribution service 18) to have their own interactive media broadcasts. Viewers (i.e. content consumers 16) can interact with broadcast media 12 via: live group chat; sending “Likes” (e.g. appreciation of the broadcast media content 12 and/or content provider 14 without transaction); and transacting goods and services available (e.g. for sale) associated with the broad media content 12. Broadcasters can monetize their fan base in media content sharing environment 10. By combining mobile transactions/payments, social networking and media content sharing, the environment 10 creates a unique social commerce platform that facilitates individuals and organizations alike to monetize their social media following.

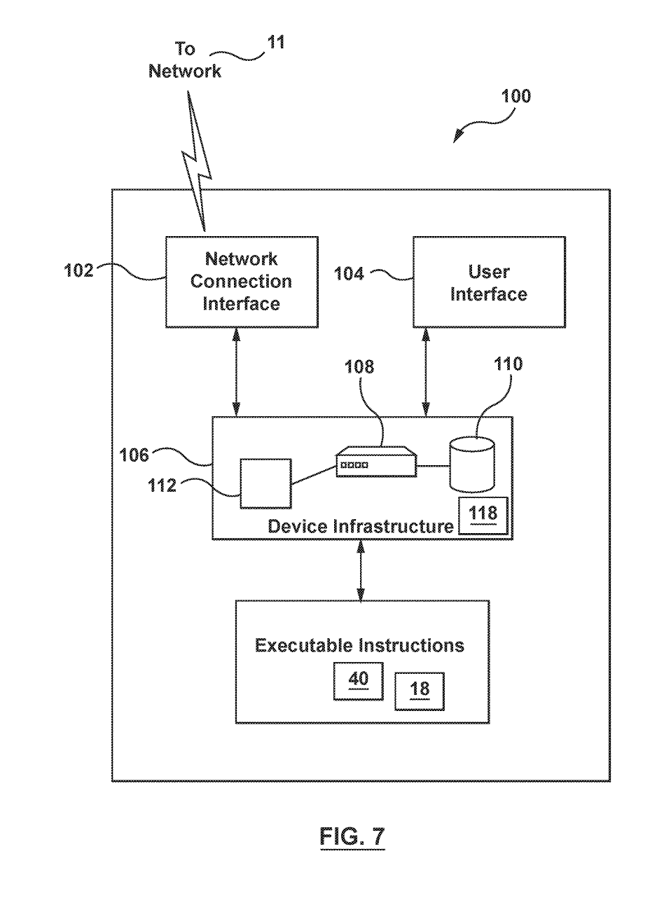

Referring again to FIG. 1, shown is the media content sharing environment 10 for distributing the media content 12 over the communications network 11 between the content provider 14 and the one or more content consumers 16 via the media distribution service 18. Interaction of the content providers 14 and the content consumers 16 with the media distribution service 18 can be via a service client application 40 provisioned as a dedicated client application (e.g. app downloaded from the media distribution service 18 or online application store) on the computer devices 100 (such as a smart phone—see FIG. 7) facilitating the roles of the content providers 14 and the content consumers 16 in the media content sharing environment 10. In this case the service client application 40 can be registered as a dedicated client application (e.g. app) of the media distribution service 18 configured for operation in a client-server relationship therewith. Alternatively, the service client application 40 can be provided via a generic web browser provisioned in the computer device 100 when interacting with the media distribution service 18 exposed as a web service/portal on the network 11 via an appropriate URL (accessed via the browser). It is recognised the media distribution service 18 can be operated on a computer device 100 (e.g. server) coupled to the network 11. The communications network 11 can be provided as an extranet, e.g. the Internet or World Wide Web (e.g. web), for facilitating network communications between the computer devices 100 (e.g. hosting the media distribution service 18, the content provider 14, the content consumer 16). As such, the media content sharing environment 10 can be provided as an Internet construct for facilitating the provision and consumption of the media content 12 between the media distribution service 18, the content providers 14 and the content consumers 16, such that the network 11 communications are configured as machine to machine electronic communications using appropriate network 11 communication protocols (e.g. HTML). The media content 12 can be generated by the computer device 100 of the content provider 14 (e.g. pictures/video images recorded by a camera of the computer device 100, text input via a user interface of the computer device 100, etc) for subsequent upload as the media content 12 to the media distribution service 18 via the network 11.

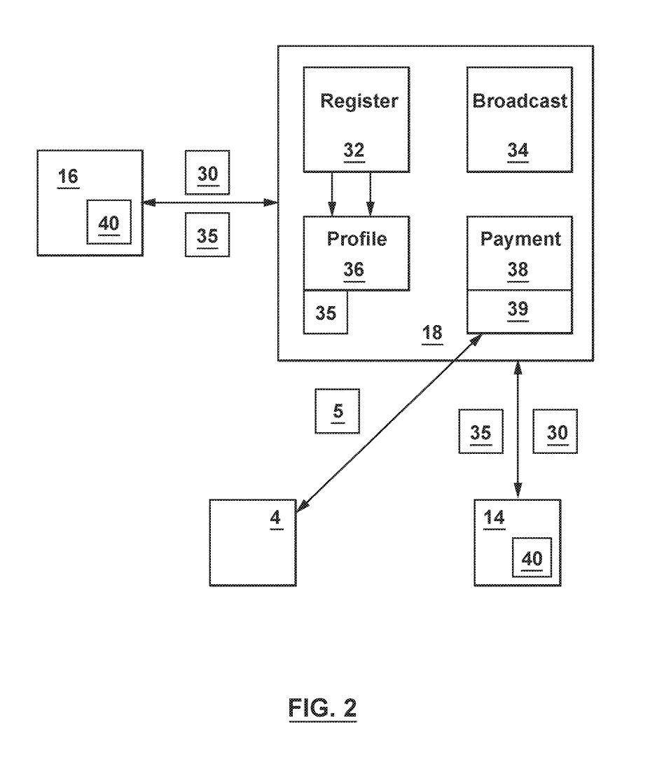

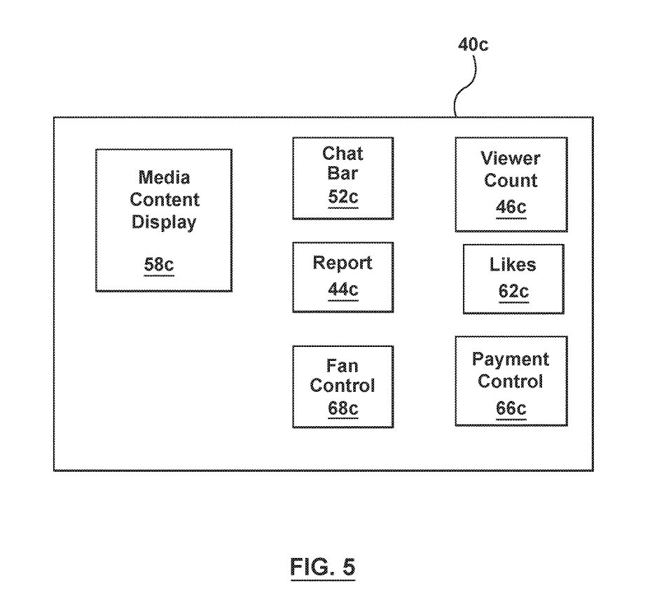

Using the service client application 40 can be done in the environment 10, as operated by the content provider 14 in order to coordinate how and when the media content 12 is broadcast via the service 18 to one or more content consumers 16. Using the service client application 40 can be done in the environment 10, as operated by the content consumer 16 in order to coordinate the degree of interaction (e.g. level of payment/transaction amount provided to the content provider 14, messaging (e.g. chat, submission of likes, selection as a follower/fan, etc.) with the content provider 14 or other content consumers 16 prior to/post/or during the broadcast of the media content 12, and/or manage how the content consumer 16 receives or does not receive (e.g. blocked/restricted access) the media content 12. As such, the content consumer 16 and the content provider 14 connect to the service 18 via the service client application 40 in order to play their respective roles in the environment 10 associated with the media content 12, as further described below. In terms of the media content 12, broadcast of such can be referred to as a broadcast session which can be initiated and/or terminated by the content consumer 16/provider 14 using the service client application 40. For example, the content provider 14 can use the service client application 40 to coordinate selected media content 12 (and any associated products/services) availability to one or more content consumers 16, as well as to coordinate transaction requests (e.g. via displayed transaction control 66c—see FIG. 5) and associated transaction responses (e.g. received transaction amounts received as a consequence of activation of the transaction control 66c by the content consumer 16). The service 18 can coordinate deposit and withdrawal transactions, on behalf of the content providers 14 and consumers 16 based on knowledge of their respective financial/transaction accounts (as defined in the user accounts 36 of the members 14,16—see FIG. 2), related to the provision/consumption (i.e. viewing) of the media content 12.

The media content 12 can be media types such as but not limited to: a news feed; a blog; a video stream; one or more images; chat content; and/or other messaging content in which the content provider 14 and the content consumer 16 are in bilateral communication over the network 11 via the service 18 (i.e. the content provider 14 and the content consumer 16 are registered members of the service 18). The media content 12 can be, in the case of a media video stream (e.g. news feed, performance/concert feed, etc.), a live or pre-recorded event. For example, in the case of chat content, the content provider 14 and content consumer 16 roles could change during the chat communications depending upon which is sending the content 12 to the other and which is receiving the content 12 from the other via the media distribution service 18. As such, the media distribution service 18 is responsible for receiving media content 12 from the content provider(s) 14 and broadcasting the received media content 12 to one or more content consumers 16 over the network 11. It is recognised that the content providers 14 and the content consumers 16 are registered members of the media distribution service 18, as further described below. As such, the content provider 14 can direct the media distribution service 18 to broadcast their media content 12 to a selected set of the service members (e.g. to specified members of a group) or can direct the media distribution service 18 to broadcast their media content 12 generally to members of the media distribution service 18, as further described below. In cases where a selected (by the content provider 14) content consumer 16 is not a member of the media distribution service 18, the media distribution service 18 can first send the selected content consumer 16 a registration request 30 (see FIG. 2) for completion before proceeding to enable the selected content consumer 16 to receive the media content 12 of the content provider 14.

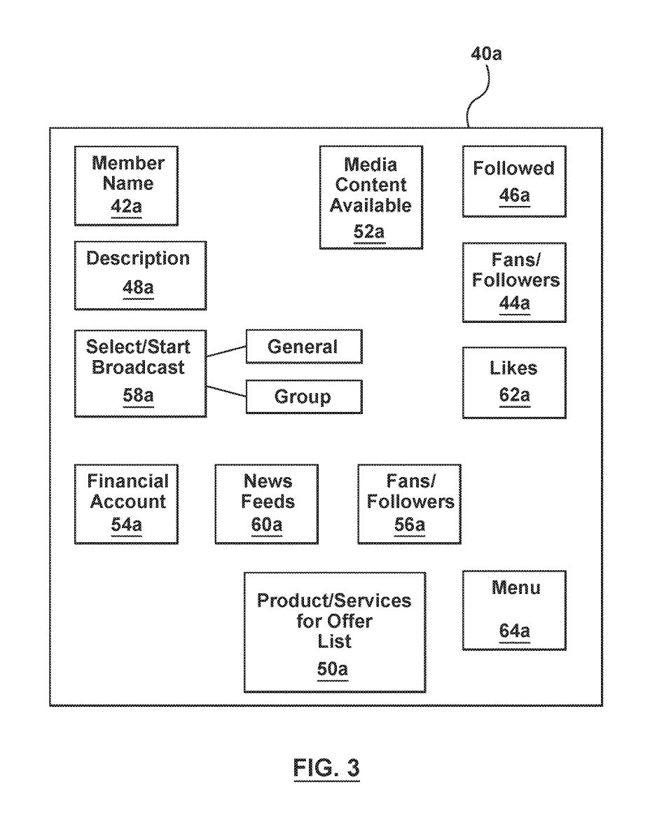

For example, newsfeeds 12 can be defined as a standard single profile newsfeed containing updates from members (of the media distribution service 18) that a member is following (e.g. listed in the followed list 46a of the member profile represented by profile account screen 40a (see FIG. 3). A follower/fan is similar in concept to a friend or potential customer of the content provider 14, like followers on Twitter™. The broadcast sessions of the media content 12 can be viewed by anyone that is logged in (i.e. is a member of the media distribution system 18), therefore as one example embodiment a member does not have to be a fan/follower of a particular content provider 14 to view their broadcast as the broadcasts can be open to the membership public. An alternative embodiment is where a member does have to be a fan/follower of a particular content provider 14 in order to view their broadcast, as their broadcasts can be only open (i.e. restricted to) select members selected from the contact list 44a,44b,46b (see FIGS. 3,4) by the content provider 14. This embodiment is also referred to as a private or group broadcast.

It is recognised that in a group scenario, different members of the group can participate with the media distribution service 18 as both a provider 14 and/or a consider 16 for the group, depending upon whether the group member is participating in the group by sending or receiving media content 12. For example, group member A is acting as a content provider 14 if the group member A provides first media content 12 (e.g. chat text as a question to the group) to the media distribution service 18 for broadcasting over the network 11 to other designated group members B, C, etc, i.e. acting as the content consumers 16 of the broadcast first media content 12. Subsequently, group member B can act as content provider 14 to group member A, C by providing second media content 12 (e.g. chat text as a response to the group) to the media distribution service 18 for broadcasting over the network 11 to other designated group members B, C, etc, i.e. acting now as the content consumers 16 of the broadcast second media content 12. It is also recognised that the group scenario can be used in a more traditional sense with the content provider 14 and a plurality of content consumers 16, such that the content provider 14 provides the media content 12 (e.g. streaming video content) to the media distribution service 18 for subsequent broadcast over the network 11 to the others of the group designated as the content consumers 16. It is also recognised that the media content 12 can contain a plurality of different media types for a particular broadcast session for members of a group, for example video streaming and chat content.

As such, it is recognised that the environment 10 can be operated as a single content provider 14 broadcasting media content 12 to one or more content consumers 16 during the broadcast session. Alternatively, the environment 10 can be operated as a single content provider 14 broadcasting media content 12 to one or more content consumers 16, the number of which varies during the broadcast session. Alternatively, the environment 10 can be operated as a multiple content providers 14 broadcasting media content 12 to multiple content consumers 16 during the broadcast session, such that the roles of the members change between content provider 14 and content consumer 16 depending upon whether they are submitting media content 12 to the service 18 for network 11 broadcast or are receiving media content 12 from the service 18 as a network 11 broadcast. It is recognised that any of the operations of the environment 10 can be done alone or together, for example one of the members can be a content provider 14 for a music stream session to a plurality of content consumers 16 as a group while some of the content consumers 16 can become content providers 14 in terms of chat media content 12 broadcast in tandem with the music stream.

Referring to FIG. 2, the media distribution service 18 provides a registration interface 32 for sending registration requests 30 to various potential content providers 14, consumers 16 of the media content 12 broadcast by a broadcast interface 34 in order to set up their user account profile 36, as well as (for example) facilitating administration of an existing (already registered member) user account profile 36. The registration interface 32 facilitates various entities on the network 11 to become members of the media distribution service 18, for example as a registered service user having a username in the user account profile 36. The user profile 36 can be populated by user information 35 received by the registration interface 32 in response to the registration request 30. The registration request 30 can be prompted by a membership inquiry sent to the media distribution service 18 by the potential member and/or can be prompted by selection of the entity (who is not yet a member of the media distribution service 18) for inclusion in a group (to receive broadcasts of the uploaded media content 12 to the service 18) by the content provider 14. The members can register as content consumers 16 (e.g. viewers) and/or as content providers 14 (e.g. a product/service merchant).

The user information 35 can include, for example: the user/member name (e.g. account name and/or handle/display name); listed user/member names of other members considered followers or fans (e.g. content consumers 16 for the member); listed user/member names of other members followed by the user (e.g. content providers 14 of which the member is selected as a content consumer 16 as respective media content 12 becomes available via the media distribution service 18); a description of the user/member including for example profession (e.g. musician), products or product types for sale (e.g. consumer products such as the media content itself, consumer items associated with the media content 12, etc., member provided services associated with the media content 12, etc.); media content history (e.g. recent video streams); transaction account information (e.g. account number with a financial institution, a mobile wallet account, a debit or credit card account, etc.); any required password information or login information (e.g. login password of the user/member account, passwords—for example PIN—for the transaction account); other social media accounts associated with the user account 36 (e.g. Facebook Account™); member contact information (e.g. email account, telephone number, physical address, etc.); personal information such as but not limited to birth date; and/or a list of invitees (e.g. potential members) including their contact information (e.g. phone number, email address, etc.). As such, the registration interface 32 is configured to collect the user information 35 as part of satisfying the registration request 30 and setup/maintenance of the user account profile 36 for respective members or potential members of the media distribution service 18. Further, the registration interface 32 can provide menu options when requested by members/potential members in order to coordinate changes/additions/deletions to the user information 35 of the user's account 36, for example such as but not limited to any account settings, privacy settings, invitee list names/addresses, any other profile content as listed above, and/or transaction account settings (e.g. list of transaction account numbers, passwords/PINS), etc.

As noted above, the products/services of the content provider 12 can be the media content 12 itself and/or can be separate items associate with the media content 12. The product/service can be defined as the item for which the content consumer 16 provides payment to the content provider 14. An example of the media content 12 being the product/service is a streamed performance (e.g. music, film or film clip, comedy routine, etc.), such that payment by the content consumer 16 is provided as a consequence of watching/listening to of the media content 12 provided by the content provider 14. An example of the media content 12 being in addition to the product/service is a broadcast of an infomercial, that the media content 12 is a video demonstration of the product for sale (e.g. consumer item) with associated commentary of the product. In this case, the content consumer 16 watches the media content 12 in order to ascertain whether they wish to obtain/own the offered consumer product. It is recognised that in terms of products/services, in economics, economic output is divided into goods and services. When an economic activity yields a valuable or useful thing, it can be known as production output of the totality of products (e.g. goods or services) in an economy that the company (e.g. content provider 14) makes available for use by the content consumer 16. Products as goods can range from a simple safety pin, food, clothing, computer components to complex aircraft. Products as services are the performance of any duties or work for another (e.g. helpful or professional activity such as a performance) and can be used to define intangible specialized economic activities such as but not limited to: providing access to specific information; web services; transport; banking; legal advice; accounting advice; management consultant advice; entertainment services (e.g. comedy, music, video entertainment, etc.), and medical services. The content provider 14 providing the products can be a businessperson/individual engaged in wholesale/retail trade, an organization, an administration, and/or a business that sells, administers, maintains, charges for or otherwise makes available product(s) that are desirable by the content consumer 16. Accordingly, the content provider 14 can be one person, or an association of persons, for the purpose of carrying on some enterprise or business; a corporation; a firm; etc. Further, it is recognised that the use of the media content 12 can be applied to direct the content consumer 16 to company activities not related to specific product(s), for example customer service, community activities, and/or sponsorships. These general activities of the content provider 14 are also considered as part of the definition of products/services.

Referring to FIG. 3, shown is an example user interface of the service client application 40 configured as a profile screen 40a (e.g. displayed on the user interface of their computer device 100) for a member having their user account 36 with the media distribution service 18. The profile screen 40a can have the member name 42a, listed user/member names 44a of other members considered followers or fans (e.g. content consumers 16 for the member including their contact information such as phone number, email address, etc., listed user/member names 46a of other members followed by the user (e.g. content providers 14 of which the member is selected as a content consumer 16 as respective media content 12 becomes available via the media distribution service 18 including their contact information such as phone number, email address, etc.), description 48a of the user/member including for example profession (e.g. musician, other social media accounts associated with the user account, member contact information such as email account, telephone number, physical address, personal information such as but not limited to birth date), products or product types 50a for sale (e.g. consumer products such as music content, consumer items, etc., member provided services, etc.) to associate with a particular media content 12 of the available media content 52a, media content available 52a (e.g. recent video streams); transaction account information 54a (e.g. account number with a financial institution, a mobile wallet account, a debit or credit card account, etc.) with any required password information or login information (e.g. login password of the user/member account, passwords—for example PIN—for the transaction account), a service search function 56a, a start/upload media content button/control 58a (e.g. for selecting content consumers 16 as general broadcast or part of a specified group, for selecting media content 12 for upload to the media broadcast service 18), any member news feeds 60a subscribed to via the service 18, a list of likes 62a received from members, and/or a menu 64a for the menu options in order to coordinate changes/additions/deletions to the user information 35 of the user's account 36, for example such as but not limited to any account settings, privacy settings, invitee list names/addresses, any other profile content as listed above, and/or transaction account settings (e.g. list of transaction account numbers, passwords/PINS), etc.

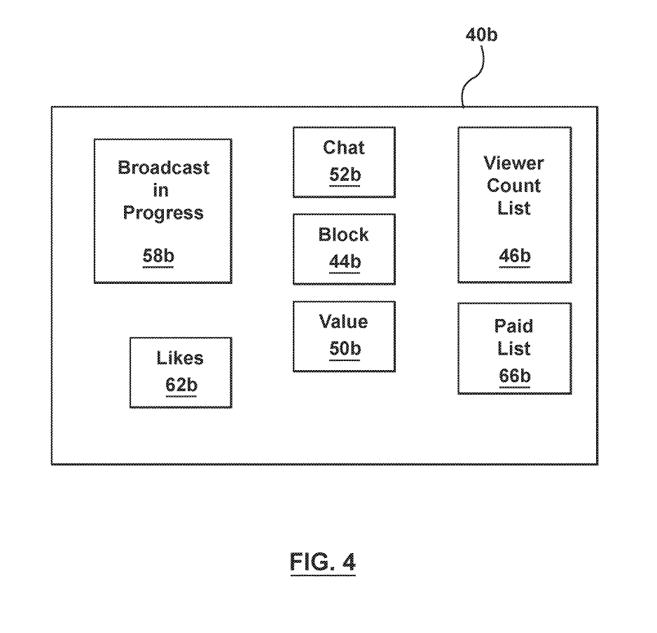

Referring to FIG. 4, shown is an example user interface of the service client application 40 configured as a broadcast screen 40b (e.g. displayed on the user interface of their computer device 100) for the member once they have selected for broadcast their media content 12 via the broadcast control 58a of the profile screen 40a (see FIG. 3). The broadcast screen 40b can have a copy 58b of the broadcasting (live via the service 18) media content 12 in progress (e.g. a broadcast session that lasts as long as the media content 12 is broadcast via the service 18 and/or the service 18 accepts transactions sent from the content consumer(s) 16 associated with the broadcast media content 12), a chat selection control 52b for viewing/hiding chats as well as for interacting with ongoing/initiated chats with other members of the service 18, a block/report member control 44b that can be selected by the member to report or otherwise block selected members from the respective member's media content 12, a set transaction value control 50b for setting a transaction amount for any product/service associated with the media content 12 being broadcast (e.g. as shown in the copy 58b)—for example the transaction value control 52b can be used by the content provider 14 to set minimum transaction amount per activation of a transaction control 66c (see FIG. 5) or restrict the initial broadcast (or continued broadcast) of the media content 12 to paying members only (i.e. those listed in a paid list 66b), and/or the paid list 66b of fans/members that have sent funds for the product/service associated with the media content 12. It is recognised that the media content 12 itself could be the product/service associated with the value control 50b, for example a concert, presentation, performance, etc. Further, the broadcast screen 40b can have a viewer counter/name list 46b for the media content 12 being broadcast as represented in the copy 58b. As such, the content provider 14 can manage via the broadcast screen 40b the media content 12 in current broadcast as well as the interactions with the other members (e.g. content consumers 16) associated with the broadcast. For example, the content provider 14 can use the chat control 52b to initiate or otherwise respond to a message with one or more of the content consumers 16, can be kept informed by reported viewer names/counts via the control 46b and respective payments via the paid control 66b (for example the content provider 14 can select from the control 46b any content consumer(s) 16 to send network message(s) to (e.g. “how do you like the show?”, “thank you for your payment/contribution”, etc.), can block (e.g. instruct the service 18 to restrict broadcast of the media content 12 to the blocked content consumer 16) selected content consumers 16 via the block control 44b, and/or can adjust the value of the product service associated with the media content 12 via the value control 50b.

Referring to FIG. 5, shown is an example user interface of the service client application 40 configured as a media display screen 40c (e.g. displayed on the user interface of their computer device 100) for the member (i.e. content consumer 16) once they have received any broadcast of media content 12 from the content provider 14 (e.g. as invited by the broadcast provider 14 and/or as selected via the follower control 46a of their profile screen 40a (see FIG. 3). The media display screen 40c can have display 58c of the media content 12 (e.g. video stream) received from the content provider 14 via the service 18, the transaction control 66c (e.g. when activated by the content consumer 16 results in payment of the payment value being sent to the content provider 14 via the service 18—such that the transaction amount and associated name/ID of the content consumer 16 is listed in the paid list 66b of the broadcast screen 40b of the content provider 14), a like control 62c for activation by the content consumer 16 in order to populate a like by the content consumer 16 in the like control 62a,b of the screens 40a,40b (for example a like can be considered as a transaction of zero value from the content consumer 16 to the content provider 14), viewer counter control 46c for listing the current/historical viewers (as content consumers 16) of the media content 12 in the display 58c (for example the content consumer 16 can select one or more viewers listed in the control 46c in order to initiate a chat with the selected viewer member as coordinated via a chat bar control 52c), a report control 44c for selection by the content consumer 16 in the event they consider the media content 12 of the display 58c inappropriate, a fan control 68c for selecting by the content consumer 16 to become a fan of the media content 12 on display or to otherwise become a fan of the content provider 14 in general (e.g. activation of the fan control 68c would result in population of the member name/ID in the fans/followers list 44a of the screen 40a of the content provider 14, and/or a close control 70c for ending the display if the media content 12 or otherwise closing the application screen 40c.

As further described below, the transaction control 66c (e.g. active button, link, etc) can display a fixed transaction amount that will be deposited into the transaction account of the content provider 14 from the transaction account of the content consumer 16 (as facilitated by a payment engine of the service 18—further described below), once the control 66c is activated by the content consumer 16. Alternatively, the transaction control 66c can provide the ability for the content consumer 16 to specify a transaction amount and/or to display a total amount of transaction accumulated throughout the session as a consequence of multiple activations of the transaction control 66c. Alternatively, the transaction control 66c can be configured to display and respond to a transaction request (for a transaction amount) sent directly to the content consumer 16 by the content provider 14. The transaction amount can be a transaction amount suggestion that is simply accepted by the content consumer 16, a generic transaction amount for any amount that can be set by the content consumer 16 in response to the transaction request/invitation by the content provider 14, and/or a volunteer transaction amount initiated by the content consumer 16 prior to receipt of any transaction request by the content provider 14. As such, it is recognised that the transaction (e.g. payment/financial) amount associated with the transaction control 66c can be fixed or variable, as set by the content provider 14 or content consumer 16, as desired.

Disclosed herein is a system that marries mobile commerce with, as an example e-commerce, for media content 12 access (and products/services associated therewith) in ways never anticipated before while simultaneously addressing persistent issues in e-commerce: shopper confidence, access to marketplace buyers and sellers and abandoned sales.

The conventional industry approach to marrying mobile commerce and e commerce has been to make mobile devices web capable. This is to say that the general trend in the technology industry has been to develop technologies that allow a consumer (e.g. content consumer 16) to browse and transact from websites via his/her mobile device. A standard e-commerce transaction allows a consumer to use a personal computer to access the Internet, browse to a website, shop online, fill out any forms that the seller (e.g. content provider 14) needs to complete the transaction and finally pay for the transaction online. The embodiments disclosed herein make a mobile device complementary to a standard e-commerce transaction. This is done by providing the consumer to access a transaction platform 4 to facilitate the payment and form fill out components of the online transactions 5, without the need for any transfer of transaction account information directly between the seller and the consumer.

In addition, some consumers are reluctant or unwilling to shop online due to real and perceived security concerns associated with directly exposing personal transaction account (e.g. financial accounts 54a) information online or otherwise to the seller. The embodiments disclosed herein can provide consumers the ability to pay for purchases with the seller by interacting with the transaction 5 via his/her mobile device 100, without the consumer exposing his/her transaction account information to the seller on a transaction per transaction basis. In addition, the payment engine 38 can expedite the transaction procedure by auto-populating any forms (of the seller) that are to be filled out as part of the transaction process associated with the transaction 5.

The media distribution service 18 has the transaction engine 38 operating via a transaction interface 39 (e.g. transaction network 11 interface) for brokering transaction amounts between financial accounts of the content consumer(s) 16 and the content provider(s) 14 for payment transactions 5 settled via the transaction platform 4 (e.g. one or more financial institutions holding financial accounts of the content consumers 16 and content providers 14, the financial accounts accessed via the financial account information 54a of screen 40a—see FIG. 3). It is also recognised that the media distribution service 18 can also coordinate balances for any mobile wallets (a form of financial account administered by the transaction engine 38) held by the content consumers 16 or content providers 14 with the media distribution service 18, such that the transactions 5 can involve transfer of funds (e.g. transaction amounts based on activation of the transaction control 66c of FIG. 5) between wallets, transfer of funds between transaction accounts held in the transaction platform 4 and/or transfer of funds between a transaction account held in the transaction platform 4 and a wallet held by the media distribution service 18.

Further, the transaction engine 38 communicates via the communications network 11 with the transaction platform 4 that performs the settlement (e.g. debit of funds specified in the transaction 5 from the transaction account associated with the content consumer 16 and crediting of the funds in to a transaction account of the content provider 14) of any required funds transfer in the transaction 5 between the transaction accounts (e.g. the seller account and the buyer account). It is recognized that the actual amount of debit and credit actions performed by the transaction platform 4 may not exactly match the transaction amount specified in the transaction 5 as populated by activation of the transaction control 66c, due to applied service charges by the media distribution service 18. For example, a transaction request of $5 from one transaction account to another transaction account could result in an actual debited amount of $5.02 (representing an included $0.02 service charge to the content consumer 16) and/or an actual credited amount of $4.98 (representing an included $0.02 service charge to the content provider 14). Therefore, it is anticipated that processing of the electronic transfer of the transaction 5 can involve a transaction service charge (optional) being charged to the content consumer 16 and/or the content provider 14 in order to complete the funds transfer of the transaction 5.

Transaction 5 settlement can be defined as where the transaction amount (e.g. financial component of the transaction 5) is transferred (via the transaction platform 4 as facilitated by the transaction engine 38) from the one account to the other account, i.e. the credit and debit transactions of the transaction amount against the respective accounts are either performed (e.g. in real time) or promised to be performed (e.g. included in a batch transaction to be performed later in the day or following business day).

It is recognized that network 11 communication messages facilitating the processing of the transaction 5 are preferably between each of the client applications 40 (of the content consumer 16 and the content provider 14 and the transaction platform 4 directly (as brokered by the media distribution service 18), rather than directly between the client applications 40 themselves (i.e. directly meaning without interaction with the transaction engine 38). Therefore, in one embodiment, in the event that the client applications 40 need (e.g. request) information from one another, these request (and response) network 11 messages would go through the transaction engine 38 acting as an intermediary network interface 39 between the client applications 40 to effect any purchase transactions 5. However, it is recognized that network 11 messaging directly between the client applications 40 can also be configured, for example for the purpose of gathering information relevant to generation and/or processing of the transaction 5 as desired.

Transaction Account Information 54a (see FIG. 5)—Sensitive information pertaining to the transaction Account of the content consumer 16 or the content provider 14, including but not limited to account holder's name, a picture of the account holder, name of financial institution, account login information, account numbers, account balances, passwords and PIN numbers for accessing the account. It is recognized that the transaction account information 54a is used by the transaction platform 4 (as provided by the transaction engine 38) to access and effect the actual transfer of funds from the identified account of the content consumer 16 from the transaction account information 54a to the identified account of the content provider 14 from the transaction account information 54a.

The backend fulfillment process can be handled by the transaction platform 4 (e.g., delivery/pickup instructions, transaction processing, etc.), as authorized by the provided content consumer 16 transaction account information 54a and associated login/authentication information (e.g. PIN) provided by the content consumer 16 (e.g. for transaction amounts over a specified threshold as configured in the account information 54a) preferably via the mobile device 100 in network communications between the transaction engine 38 (via the transaction interface 39) and the mobile device 100 (via client application 40) in a network communication path on the network 11 that bypasses the client application 40 of the content provider 14.

As can be appreciated, the environment 10 provides for the content provider 14 to broadcast media content 12 to a plurality of content consumers 16 simultaneously (e.g. as a general broadcast and/or to specified content consumers 14 belonging to a consumer group specified by the content provider 14) and to therefore collect transaction amounts (via activation by each of the content consumers 16 of their transaction control 66c provided on their display screen 40c by their client application 40) for the content provider 14 from a plurality of the content consumers 16 (e.g. a many to one transaction amount collection, a group transaction amount collection, etc.). As can be appreciated, the transaction amount associated with the transaction control 66c can be preconfigured by the content provider 14 (e.g. a set price for the product/service associated with the media content 12) and/or the transaction amount can be set or otherwise modified by the content consumer 16 (e.g. a tip amount or micro transaction for viewing the media content 12 provided as appreciation to the content provider 14 by the content consumer 16). The transaction amount can be displayed on or otherwise associated with the transaction control 66c displayed on the viewing screen 40c of the content consumer 16, such that the content consumer 16 is aware that activation of the transaction control 66c (clicking the button) will result in sending of the displayed transaction amount to the content provider 14 (via the payment engine 38).

Referring to FIGS. 1 and 2, the environment 10 provides for the requestor (e.g. member 14,16) of a transaction 5 to select a transaction amount that results in the transaction control (e.g. payment button) of the viewer's (e.g. member 14,16) mobile application 40 to be configured to a preset transaction amount entered by the requestor. This can provide for the viewer being allowed to complete a transaction 5 for any goods or services offered by the broadcaster (e.g. content provider 14) by activation of the displayed transaction control 66c (see FIG. 5), e.g. a single tap of the payment button. The environment 10 can be used for streaming video transactions, chat transactions and any other transaction wherein the requestor and viewer are in bilateral communications with one another via their computer applications 40 brokered by the media distribution service 18.

The service 18 is configured so that a mobile payments infrastructure (e.g. transaction platform 4 with associated transaction engine 38): recognizes the viewer and requestor by their username (member ID) in the system; is able to query both the requestors mobile payments profile 54a to determine whether or not funds are available and if not is also able to process a payment through a payment gateway (e.g. transaction platform 4) to a financial institution or telecommunications carrier.

Referring to FIGS. 1,2 and 6, the media content distribution framework 10 for sharing media content 12 over a network 11 and for coordinating transactions 5 associated with the shared media content 12 can at step 200 register by a registration engine 32 a plurality of content consumers 16 as members of the framework 10 by creating a respective profile account 36 for each content consumer 16 of the plurality of content consumers 16, each respective profile account 36 including respective member information 35 including respective member identification (ID) and consumer transaction account information. At step 202, the registration engine 32 can register a content provider 14 as member of the framework 10 by creating a respective profile account 36 for the content provider 14 including a respective member ID and provider transaction account information. At step 204, the broadcast engine 34 can receive a broadcast session request over the network 11 from the content provider 14 including the media content 12 via a provider client application 40 coupled to the framework 10 (e.g. service 18). At step 206, the broadcast engine 34 broadcasts the media content 12 to the plurality of content consumers 16 over the network 11 for display on respective consumer computer user interfaces via respective consumer client applications 40 coupled to the service 18. At step 208, the transaction engine 38 receives a transaction amount from one or more of the plurality of content consumers 16, the transaction amount resulting from activation of a transaction control 66c displayed by the consumer client application 40c on the consumer computer interface, the transaction control 66c associated with the media content 12 and including a displayed transaction amount representing the transaction amount. At step 210, sending over the network 11 a transaction request 5 for settlement to a transaction platform 4, the transaction request 5 including the transaction amount, the provider transaction account information and the consumer transaction account information from the one or more of the plurality of content consumers 16.

It is recognised that other functionality of the environment 10 can include: receive from the content provider 14 a selected member group from the plurality of content consumers 16 and restrict the broadcast session to the consumer client applications 40c included in the selected member group; the provider client application 40b can have a broadcast screen for display on a provider computer user interface including a member selection control 44a for restricting the broadcast session to the selected member group from the plurality of content consumers 16; and the provider client application 40b can have a product selection control 50b for associating a product with the media content 12. It is appreciated that the product can be the media content 12. It is appreciated that the transaction amount can be for ownership of the product by the content consumer 16 and/or compensation for viewing of the media content 12. It is also recognised that the content provider 14 can provide a set transaction amount for use as the displayed transaction amount.

The environment 10 can also include a method for receiving media content 12 shared over a network 11 and for coordinating transactions 5 associated with the shared media content 12, the method executed on a computer system of the content consumer 16 using instructions stored on a storage for: registering as a content consumer member of a distribution service by obtaining a profile account with the distribution service, the profile account including member information including a member identification (ID) and consumer transaction account information; receiving notification on a user interface of the computer system of a broadcast session over the network from the distribution service for media content provided by a content provider; displaying a broadcast of the media content on the user interface via a consumer client application coupled to the distribution service; generating a transaction amount resulting from activation of a transaction control displayed by the consumer client application on the user interface, the transaction control associated with the media content and a displayed transaction amount representing the transaction amount; and sending over the network the transaction amount for subsequent settlement with a transaction platform as brokered by the distribution service.

The environment 10 can also include a method for broadcasting media content 12 shared over a network 11 and for coordinating transactions 5 associated with the shared media content 12, the method executed on a computer system of the content provider 14 using instructions stored on a storage for: registering as a content provider member of a distribution service by obtaining a profile account with the distribution service, the profile account including member information including a member identification (ID) and provider transaction account information; submitting via a user interface of the computer system notification of a broadcast session over the network to the distribution service for media content provided by the content provider; sending the media content to the distribution service for subsequent display as a broadcast of the media content on a user interface of a consumer client application coupled to the distribution service; and receiving a transaction amount resulting from activation of a transaction control displayed by the consumer client application on the user interface of the consumer client application, the transaction control associated with the media content and including a displayed transaction amount representing the transaction amount.

Referring to FIG. 7, each computer device 100 for the content consumers 16 or the content providers 14 can be a wireless-enabled (e.g. WiFi, WAN, etc.) personal data assistant, or email-enabled wireless telephone, or a desktop computer terminal. In addition, the wireless communications are not limited to only facilitating transmission/broadcast/receipt of text data and can therefore be used to operate image data, audio data or multimedia data, for example, as desired.

As shown in FIG. 7, the computer device 100 comprises a communication network interface 102, a user interface 104, and a data processing system 106 in communication with the network interface 102 and the user interface 104. The network interface 102 can include one or more antennas for wireless communication over the communications network 11. Preferably, the user interface 104 comprises a data entry device (such as keyboard, microphone or writing tablet), and a display device (such as an LCD display). The display screen of the user interface 104 can be used to visually present a graphical user interface (GUI) of the client application 40 (e.g. dedicated app, browser, etc.) to the user for generating/viewing the media content 12. The display screen can employ a touch screen display, in which case the user can manipulate (i.e. enter and/or modify/delete) transaction 5 related information, profile information 35, as well as media content 12 related broadcast and viewing configuration.

The data processing system 106 includes a central processing unit (CPU) 108, otherwise referred to as a computer processor, and a non-volatile memory storage device (e.g. DISC) 110 (such as a magnetic disc memory or electronic memory) and a read/write memory (RAM) 112 both in communication with the CPU 108. The memory 110 includes data which, when loaded into the RAM, comprise processor instructions for the CPU 108 which define memory objects for allowing the computer 100 to communicate with one another and the media distribution service 18 server (e.g. engines 32,34,36,38). The processor instructions for the CPU 108 will be discussed in greater detail below.

The CPU 108 is configured for execution of the application 40 (including for example some or all of the system functionality) for facilitating communication between the computer device 100 of the members 14,16 and the computer device 100 of the service 18. For example, it is recognized that the application 40 is used to coordinate, as implemented by the CPU 108, the generation, receipt, and processing of the media content 12 and the transaction 5 messaging. For example, the transaction application 40 can operate an imager 118 for capturing the media content 12 for submission to the media service 18.

The CPU 108 facilitates performance of the computer device 100 configured for the intended task (e.g. of the respective module(s) 32,34,36,38 of service or the application 40) through operation of the network interface 102, the user interface 104 and other application programs/hardware (e.g. web browser made available) of the computer device 100 by executing task related instructions. These task related instructions can be provided by an operating system, and/or software applications located in memory, and/or by operability that is configured into the electronic/digital circuitry of the processor(s) 108 designed to perform the specific task(s), including operation of the modules associated with the functionality of the systems. Further, it is recognized that the device infrastructure 106 can include a computer readable storage medium 110 coupled to the processor 108 for providing instructions to the processor 108 and/or to load/update the instructions. The computer readable medium 110 can include hardware and/or software such as, by way of example only, memory cards such as flash memory or other solid-state memory.

Further, it is recognized that the computer device 100 can include the executable applications comprising code or machine readable instructions for implementing predetermined functions/operations including those of an operating system, the imager 118, the modules 32,34,36,38 interface 39 and the application 40, and the browser, for example. The processor 108 as used herein is a configured device and/or set of machine-readable instructions for performing operations as described by example above, including those operations as performed by any or all of the imager 118, the modules 32,34,36,38,39 and the application 40. As used herein, the processor 108 may comprise any one or combination of, hardware, firmware, and/or software. The processor 108 acts upon information by manipulating, analyzing, modifying, converting or transmitting information for use by an executable procedure or an information device, and/or by routing the information with respect to an output device. The processor 108 may use or comprise the capabilities of a controller or microprocessor, for example.

The data processing system 106 includes the imager 118 (e.g. a camera including an image sensor—e.g. CCD or CMOS sensor) suitable for capturing images of the media content 12 for display or otherwise presentation by the consumer 16. The application 40 is configured to control the operation of the imager 118 to capture the images of the media content 12, if desired, if so configured, for subsequent use in generating the transaction/payment request message 5 directed to the transaction service 4. The storage 110 can also contain pre-recorded media content 12 for uploading to the media service 18.

Further, it is recognized that the device 100 can include executable applications comprising code or machine readable instructions for implementing predetermined functions/operations including those of an operating system and the modules associated with any of the functionality of the systems for example. Preferably, the device 100 is a network server for the media service 18, for example.

We claim:

1. An online media content distribution framework for sharing media content over a network and for coordinating transactions associated with the shared media content, the framework executed on a computer system using instructions stored on a storage to:
register a plurality of content consumers as members of the framework by creating a respective profile account for each content consumer of the plurality of content consumers, each respective profile account including respective member information including respective member identification (ID) and consumer transaction account information;
register a content provider as member of the framework by creating a respective profile account for the content provider including a respective member ID and provider transaction account information;
receive a broadcast session request over the network from the content provider including the media content via a provider client application coupled to the framework;
broadcast the media content to the plurality of content consumers over the network for display on respective consumer computer user interfaces via respective consumer client applications coupled to the framework;
receive a transaction amount from one or more of the plurality of content consumers, the transaction amount resulting from activation of a transaction control displayed by the consumer client application on the consumer computer interface, the transaction control associated with the media content and including a displayed transaction amount representing the transaction amount; and
send over the network a transaction request for settlement to a transaction platform, the transaction request including the transaction amount, the provider transaction account information and the consumer transaction account information from the one or more of the plurality of content consumers.

2. The framework of claim 1 further comprising the framework executed on the computer system using the instructions stored on the storage to: receive from the content provider a selected member group from the plurality of content consumers and restrict the broadcast session to the consumer client applications included in the selected member group.

3. The framework of claim 2, wherein the provider client application further comprises a broadcast screen for display on a provider computer user interface including a member selection control for restricting the broadcast session to the selected member group from the plurality of content consumers.

4. The framework of claim 2, wherein the provider client application further comprises a product selection control for associating a product with the media content.

5. The framework of claim 4, wherein the product is the media content.

6. The framework of claim 4, wherein transaction amount is for the product.

7. The framework of claim 1, wherein transaction amount is for a product associated with the media content.

8. The framework of claim 1, wherein the media content includes a streaming video provided by the content provider.

9. The framework of claim 8, wherein the media content further includes chat content provided by the content provider as well as the one or more of the plurality of content consumers.

10. The framework of claim 1 further comprising the framework executed on the computer system using the instructions stored on the storage to: receive from the content provider a set transaction amount for use as the displayed transaction amount.

11. A method for sharing media content online over a network and for coordinating transactions associated with the shared media content, the method executed on a computer system using instructions stored on a storage for:
registering a plurality of content consumers as members of a distribution service by creating a respective profile account for each content consumer of the plurality of content consumers, each respective profile account including respective member information including respective member identification (ID) and consumer transaction account information;
registering a content provider as member of the distribution service by creating a respective profile account for the content provider including a respective member ID and provider transaction account information;
receiving a broadcast session request over the network from the content provider including the media content via a provider client application coupled to the distribution service;
broadcasting the media content to the plurality of content consumers over the network for display on respective consumer computer user interfaces via respective consumer client applications coupled to the distribution service;
receiving a transaction amount from one or more of the plurality of content consumers, the transaction amount resulting from activation of a transaction control displayed by the consumer client application on the consumer computer interface, the transaction control associated with the media content and including a displayed transaction amount representing the transaction amount; and
sending over the network a transaction request for settlement to a transaction platform, the transaction request including the transaction amount, the provider transaction account information and the consumer transaction account information from the one or more of the plurality of content consumers.

12. The method of claim 11 further comprising receiving from the content provider a selected member group from the plurality of content consumers and restricting the broadcast session to the consumer client applications included in the selected member group.

13. The method of claim 12, wherein the provider client application further comprises a broadcast screen for display on a provider computer user interface including a member selection control for restricting the broadcast session to the selected member group from the plurality of content consumers.

14. The method of claim 12, wherein the provider client application further comprises a product selection control for associating a product with the media content.

15. The method of claim 14 further comprising receiving a designation of the product as the media content.

16. The method of claim 11, wherein the media content includes a streaming video provided by the content provider.

17. The method of claim 16, wherein the media content further includes chat content provided by the content provider as well as the one or more of the plurality of content consumers.

18. The method of claim 1 further comprising receiving from the content provider a set transaction amount for use as the displayed transaction amount.

19. A method for receiving media content shared online over a network and for coordinating transactions associated with the shared media content, the method executed on a computer system using instructions stored on a storage for:
registering as a content consumer member of a distribution service by obtaining a profile account with the distribution service, the profile account including member information including a member identification (ID) and consumer transaction account information;
receiving notification on a user interface of the computer system of a broadcast session over the network from the distribution service for media content provided by a content provider;
displaying a broadcast of the media content on the user interface via a consumer client application coupled to the distribution service;
generating a transaction amount resulting from activation of a transaction control displayed by the consumer client application on the user interface, the transaction control associated with the media content and a displayed transaction amount representing the transaction amount; and
sending over the network the transaction amount for subsequent settlement with a transaction platform as brokered by the distribution service.

20. A method for broadcasting media content shared online over a network and for coordinating transactions associated with the shared media content, the method executed on a computer system using instructions stored on a storage for:
registering as a content provider member of a distribution service by obtaining a profile account with the distribution service, the profile account including member information including a member identification (ID) and provider transaction account information;
submitting via a user interface of the computer system notification of a broadcast session over the network to the distribution service for media content provided by the content provider;
sending the media content to the distribution service for subsequent display as a broadcast of the media content on a user interface of a consumer client application coupled to the distribution service; and
receiving a transaction amount resulting from activation of a transaction control displayed by the consumer client application on the user interface of the consumer client application, the transaction control associated with the media content and including a displayed transaction amount representing the transaction amount.
